(19) United States
(12) Patent Application Publication
(10) Pub. No.: US 2011/0064254 A1
(43) Pub. Date: Mar. 17, 2011

(54) CASE FOR PROVIDING IMPROVED AUDIO PERFORMANCE IN PORTABLE GAME CONSOLES AND OTHER DEVICES

(75) Inventors: Yunhong Li, Santa Clara, CA (US); Wei Ma, San Ramon, CA (US); Guy K. Nicholson, San Jose, CA (US)

(73) Assignee: NATIONAL SEMICONDUCTOR CORPORATION, Santa Clara, CA (US)

(21) Appl. No.: 12/879,749

(22) Filed: Sep. 10, 2010

Related U.S. Application Data
(60) Provisional application No. 61/276,350, filed on Sep. 11, 2009.

(51) Int. Cl. H04R 1/28

(52) U.S. Cl. 381/334

(57) ABSTRACT

A system includes a portable electronic device and a case configured to be placed in association with the portable electronic device. The case includes an interface configured to receive audio signals from the portable electronic device and a speaker array configured to generate audible sounds having one or more specified audio effects based on the audio signals. The case could also include an audio amplifier configured to amplify the audio signals and to provide the amplified audio signals to the speaker array. The audio amplifier could include a filter configured to filter the audio signals in order to produce the one or more specified audio effects. The case could further include a processor configured to (i) process the audio signals in order to produce the one or more specified audio effects and (ii) output the processed audio signals to the audio amplifier.

### CROSS-REFERENCE TO RELATED APPLICATION AND PRIORITY CLAIM

This application claims priority under 35 U.S.C. §119(e) to U.S. Provisional Patent Application No. 61/276,350 filed on Sept. 11, 2009, which is hereby incorporated by reference.

### TECHNICAL FIELD

This disclosure is generally directed to audio systems. More specifically, this disclosure is directed to a case for providing improved audio performance in portable game consoles and other devices.

### BACKGROUND

Portable game consoles, such as NINTENDO DS and SONY PSP devices, are extremely popular. Other portable devices that produce audible sounds, such as audio and video players and mobile telephones, are also extremely popular. The abilities of these devices are continuously improving. For instance, some portable devices are now able to play high-definition video files. Unfortunately, these portable devices often have audio systems with poor audio quality and sound field orientation. This is typically due to the limited physical size of the devices, which can prevent bigger speakers and/or a larger number of speakers from being used to provide better audio quality and sound field orientation. This is also often due to power requirements since, as portable devices, the need to minimize power consumption to prolong the time between recharging is very important.

Since portable devices are by definition small due to their portability, it is often a challenge to output enough audio energy to be impressive to a user. Potential solutions for providing higher audio quality can include increasing the size of a portable device's speakers. However, this runs counter to the size and limited energy capabilities of the portable device's battery.

### BRIEF DESCRIPTION OF DRAWINGS

For a more complete understanding of this disclosure and its features, reference is now made to the following description, taken in conjunction with the accompanying drawings, in which:

FIG. 1 illustrates an example portable device case having a speaker array according to this disclosure;

FIG. 2 illustrates an example demonstration case incorporating a speaker array according to this disclosure;

FIG. 3 illustrates an example sound field created using a portable device case having a speaker array according to this disclosure;

FIGS. 4 and 5 illustrate other example portable device cases having speaker arrays according to this disclosure; and

FIG. 6 illustrates an example content unit for customizing operation of a portable device case having a speaker array according to this disclosure.

### DETAILED DESCRIPTION

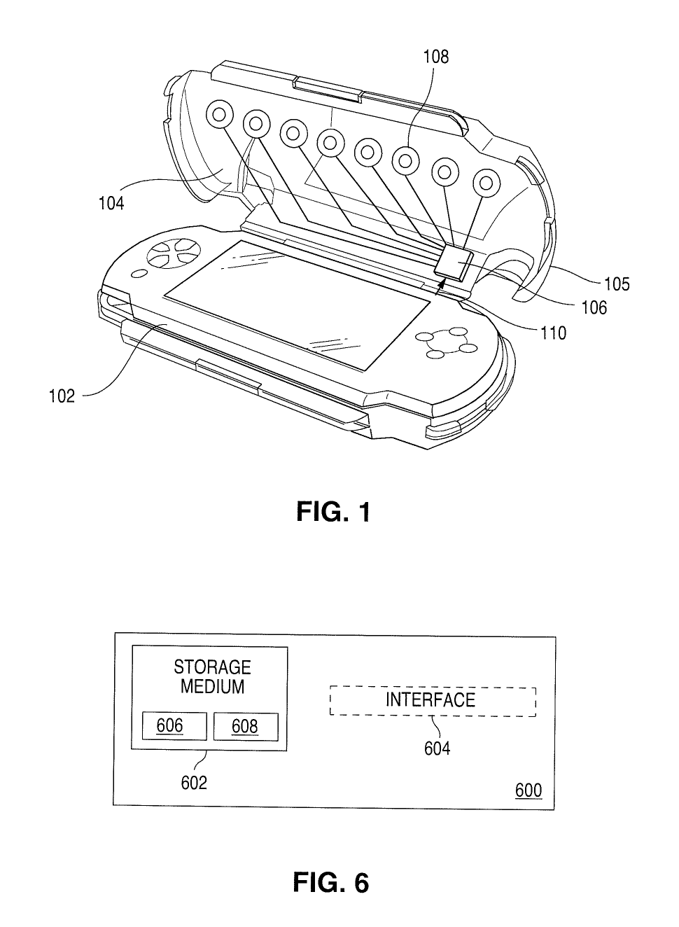

FIGS. 1 through 6, discussed below, and the various embodiments used to describe the principles of the present invention in this patent document are by way of illustration only and should not be construed in any way to limit the scope of the invention. Those skilled in the art will understand that the principles of the invention may be implemented in any type of suitably arranged device or system.

In accordance with this disclosure, a set of speakers (referred to as a “speaker array”) is incorporated into a case for a portable game console, an audio or video player, or another portable device. An audio amplifier, digital signal processor (DSP), or other component (possibly also incorporated into the case) can implement beam forming technology or other technology to produce desired audio effects, such as desired spatial effects or sound field enhancements. This may allow the speaker array to provide better audio quality with richer and broader sound fields. Moreover, the case can provide other functions, such as protection of the portable device, allowing multiple functions to be integrated in the case. Further, the time required to design and bring to market a new portable device is typically several years, meaning it is often difficult to incorporate speaker array improvements into the devices themselves. However, cases can be quickly designed and rapidly brought into the marketplace. Not only that, cases can be flexibly designed and quickly changed to meet evolving industry design requirements. In addition, cases can be customized for particular content or types of content, such as for a game or type of game being played. This may allow the audio effects produced by a case to be customized, or it may allow multiple cases to be used with a particular portable device in order to provide different audio effects.

FIG. 1 illustrates an example portable device case having a speaker array according to this disclosure. As shown in FIG. 1, a portable device 102 is used in conjunction with a case 104. Here, the portable device 102 represents a SONY PSP gaming device, although any other portable device that produces audio signals (such as another gaming device, a mobile telephone, or a media player) could be used.

The case 104 is configured to be removably or permanently attached to the portable device 102. For instance, the case 104 may be configured to receive and retain the portable device 102 within the case 104. In this example, the case 104 includes projections 105 that wrap around the sides of the portable device 102, thereby attaching the case 104 to the portable device 102. Note, however, that any suitable mechanism(s) can be used to attach the case 104 to the portable device 102.

The case 104 may also include various openings that provide a user with access to buttons or other input mechanisms on the portable device 102. Alternatively, the case 104 could include buttons, button covers, or other structures that can be depressed by the user, where those structures then depress buttons or other input mechanisms on the portable device 102. The case 104 can further include an opening or have at least a portion formed from substantially transparent material(s), which allows a user to view the screen of the portable device 102.

Note that the actual structural configuration of the case 104 shown in FIG. 1 is for illustration only and that a wide variety of cases with any number of modifications could be used with a portable device. For instance, the case 104 shown in FIG. 1 is designed for use with a particular type of portable device 102, so other portable devices could have different cases. Also, while the case 104 in FIG. 1 covers substantially only the top and sides of the portable device 102, a case could completely encase the portable device 102 (on the top, bottom, and sides).

As shown in FIG. 1, the case 104 includes an audio amplifier 106 and a speaker array 108. The audio amplifier 106 drives the speaker array 108, meaning the audio amplifier 106 provides audio signals to the speaker array 108 to cause individual speakers in the array to produce audible sounds. The audio amplifier 106 can be coupled to an output 110 of the portable device 102 so that audio signals from the portable device 102 can be received by the audio amplifier 106. This allows the audio amplifier 106 to receive and amplify audio signals being produced by the portable device 102, such as sounds related to a game being played or a video or song being played.

As described below, the audio amplifier 106 can also implement beam forming or other enhancements to form acoustic beams that provide one or more desired audio effects. This can be done, for example, by converting the audio output of the portable device 102 into phase-modified and amplitude-modified signals. In this way, the audio sounds produced by the case 104 have a higher audio quality, possibly with richer and broader sound fields.

The audio amplifier 106 includes any suitable structure for amplifying audio signals. As a particular example, the audio amplifier 106 could represent a Class AB, B, D, G, or H amplifier. The audio amplifier 106 could also include any suitable structure for performing beam forming, sound field enhancements, or other enhancements. Note, however, that the beam forming or other enhancements could be performed external to the audio amplifier 106, such as by a digital signal processor coupled to the audio amplifier 106.

In this example, the speaker array 108 includes eight speakers arranged in a row along one side running the length of the case 104. This is for illustration only. The speaker array 108 includes any suitable set of speakers, such as a set of six or eight speakers. The speakers in the speaker array 108 may also have any suitable configuration or positioning with respect to one another. Any suitable type(s) of speakers could be used in the speaker array 108, such as ceramic or moving coil type speakers. Note that the speaker array 108 could be formed from individual speakers separated from each other (such as at a 1 cm spacing), one or more speaker array modules each containing multiple speakers, a ceramic surface, or any other suitable structure(s). Each speaker in the speaker array 108 could have any suitable frequency response or other characteristics, and different types of speakers could be used in the speaker array 108.

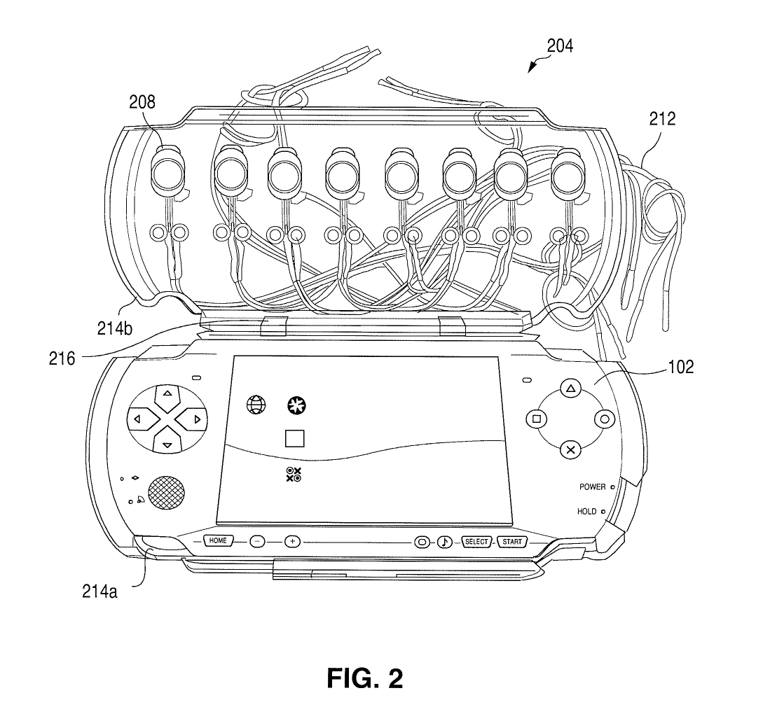

FIG. 2 illustrates an example demonstration case 204 incorporating a speaker array 208 according to this disclosure. As shown in FIG. 2, the case 204 is formed using a clear plastic or other material(s). Also, the speaker array 208 includes individual speakers mounted on the case. Note that wires 212 attached to the speakers are for demonstration purposes only. Smaller or other wires that are more difficult to see and/or wires hidden by opaque portions of the case 204 could be used.

In addition, the case 204 here includes two portions 214a-214b that are rotatably attached to one another by hinges 216 located along the top of a portable device 102. A bottom portion 214a of the case 204 covers the bottom side of the portable device 102, and a top portion 214b of the case 204 includes the speaker array 208 and covers the top side of the portable device 102. Note, however, that the use of hinges 216 is not required, and a case could have multiple portions (such as top and bottom portions) that are attached to one another or otherwise associated with one another in any suitable manner using any suitable mechanism.

Depending on the implementation, an audio amplifier, digital signal processor, or other circuitry could reside in the bottom portion 214a of the case 204 so that they are not visible to the user when using the portable device 102. Alternatively, these components could be located in the top portion 214a of the case 204 and possibly hidden by opaque portions of the case 204, or those components could be visible to the user when using the portable device 102. The bottom portion 214a of the case 204 and possibly part of the top portion 214b of the case 204 need not be formed from a transparent material.

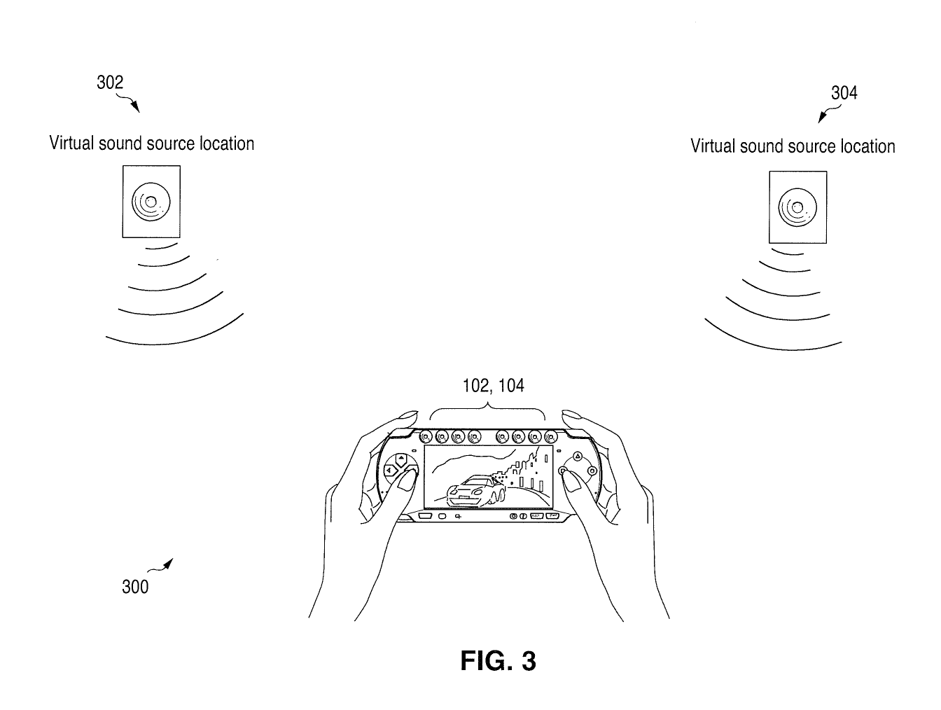

FIG. 3 illustrates an example sound field 300 created using a portable device case 104 having a speaker array 108 according to this disclosure. Using just the portable device 102, a user would typically sense audible sounds coming only from the device 102 itself. In other words, from the perspective of the user, the sounds heard by the user would appear to originate at the portable device 102.

With the use of the speaker array 108 and the beam forming or other audio effects produced by the audio amplifier 106 or other component(s), the sounds heard by the user can appear to originate at locations 302-304 other than from the portable device 102 as shown in FIG. 3. In this example, the sounds appear to originate from two locations 302-304 to the left and right of the portable device 102. It is also possible to make the sounds appear to originate in other locations, such as more to the sides and/or above the portable device 102. Further, while only two “virtual” sound sources are shown here, it is possible to make sounds appear to originate from any number of locations. This can be done using beam forming techniques or other techniques, such as those that expand the depth or width of the sound field or alter the volume of the sound.

Using this approach, a user may experience richer and fuller sound fields, which can increase the enjoyment experienced by the user. Moreover, as described above, multiple cases could be used to provide different audio effects, or a single reprogrammable case could be used to provide different audio effects. The different effects could be based on the content or type of content being presented by the portable device 102.

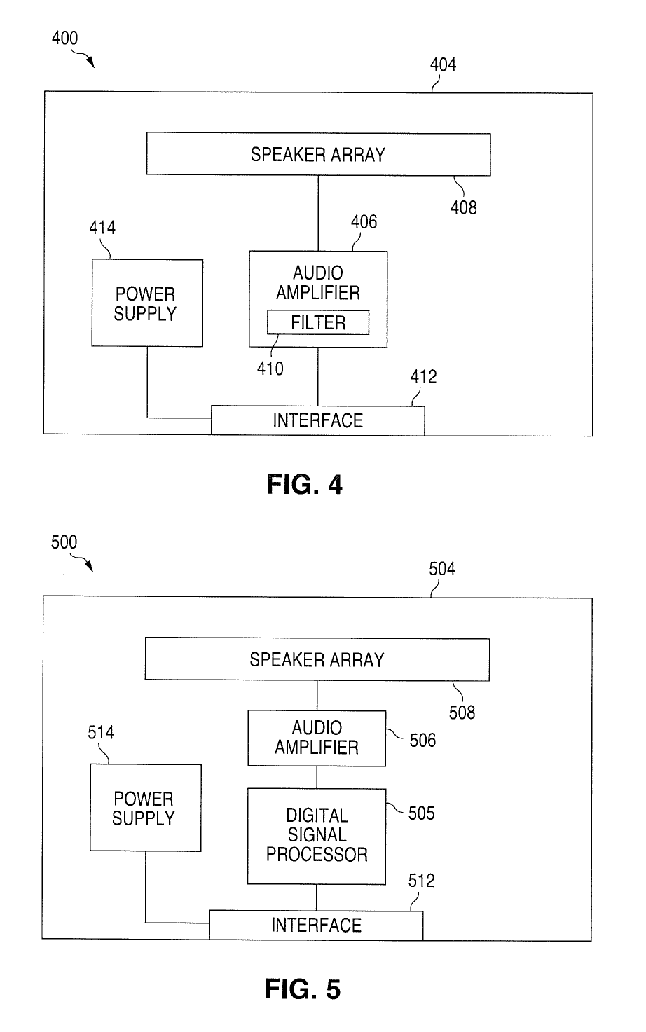

While FIGS. 1-3 above have illustrated the use of a particular case with a particular type of portable device, more generic versions of cases are shown in FIGS. 4 and 5. In particular, FIGS. 4 and 5 illustrate other example portable device cases 400 and 500 having speaker arrays according to this disclosure. As shown in FIG. 4, a case 400 includes a support structure 404, which represents the structure on or in which other components of the case 400 can be mounted. The support structure 404 is also configured to receive and retain or otherwise be attached to a portable device. The support structure 404 can vary depending on, for example, the specific type of portable device to be used with the case 400. As particular examples, the support structure 404 could represent a protection case, a holster, or a skin used with a SONY PSP device, a RIM BLACKBERRY device, an APPLE IPHONE, IPAD, or IPOD device, or other device(s).

The case 400 also includes an audio amplifier 406 and a speaker array 408. The audio amplifier 406 could represent a Class AB, B, D, G, or H amplifier, such as an amplifier from the BOOMER family of amplifiers from NATIONAL SEMICONDUCTOR CORPORATION. The speaker array 408 could include any number and type(s) of speakers, such as at least two speakers on a left side of the speaker array 408 and at least two speakers on a right side of the speaker array 408.

In this example, the audio amplifier 406 includes at least one filter 410, which can be used to filter audio data in order to implement beam forming or other sound enhancement techniques to produce one or more desired audio effects. For example, the filter 410 could operate using filter coefficients, which can be set or modified to provide the desired audio effects. Specific examples of this particular functionality are provided in U.S. Provisional Patent Application No. 61/275,748 and U.S. patent application Ser. No. 12/874,502 filed on Sept. 2, 2010 (both of which are hereby incorporated by reference). However, any other or additional beam forming, sound field enhancement, or other techniques for producing one or more desired audio effects could be implemented by the audio amplifier 406.

While a single audio amplifier 406 with a single filter 410 is shown in FIG. 4, this is for illustration only. Multiple audio amplifiers 406 (each coupled to any number of speakers) could be used, and one or multiple audio amplifiers 406 could each include one or multiple filters 410. As a particular example, a filter bank with one filter for each speaker could be used.

An interface 412 provides audio signals to the audio amplifier 406. For example, the interface 412 could represent a USB interface, a stereo “audio out” jack, or other interface that can be physically coupled to a portable device and that provides audio signals. The interface 412 could also represent a wireless interface that can wirelessly receive audio data from a portable device, which may be useful when the portable device includes a wireless local area network transceiver or other wireless transmitter or transceiver. The audio data received by the interface 412 could have any suitable form, such as analog audio signals or digital streams (such as IIS, AC97, or other data). The interface 412 includes any suitable structure for receiving audio data. While a single interface is shown in FIG. 4, multiple interfaces could also be used, such as one interface for receiving audio signals and another interface for receiving power.

A power supply 414 may optionally be included in the case 400. The power supply 414 can provide operating power to other components of the case 400, such as the audio amplifier 406. The power supply 414 could represent any suitable source of operating power, such as a battery, fuel cell, solar cell, or combination thereof. The power supply 414 could also optionally be coupled to the interface 412 to receive power from the portable device, in which case the power supply 414 could be recharged by the portable device. As a particular example, the power supply 414 could be coupled to the recharging port of the portable device. The power supply 414 could further receive power wirelessly using a wireless power transfer mechanism, such as inductive and/or resonant power transfer. As a particular example, a battery could have an attached coil used to wirelessly receive power and recharge the battery. In still other embodiments, the components of the case 400 are powered directly by the portable device, and no internal power supply 414 is needed. In general, any suitable source(s) of power could be used with the case 400.

As shown in FIG. 5, a case 500 includes a support structure 504, a digital signal processor 505, an audio amplifier 506, a speaker array 508, an interface 512, and a power supply 514. Many of these components may be the same as or similar to the corresponding components shown in FIG. 4. In this example, however, beam forming, sound field enhancements, or other techniques can be implemented using the digital signal processor 505.

FIGS. 4 and 5 have illustrated the use of different components to perform beam forming, sound field enhancements, or other techniques in order to produce one or more desired audio effects. However, it is also possible for the audio signals to be processed within a portable device itself in order to provide the desired audio effects. For instance, an audio processor or other component within the portable device could be programmed to provide the desired audio effects, possibly only when the portable device detects the presence of a suitable case. The portable device could then provide the processed audio data to the case for presentation to a user.

As noted above, different spatial effects or other audio effects could be provided depending on the content or type of content being presented on the portable device (such as the game or type of game being played). Also, as noted above, different cases could be used to provide different audio effects. It is also possible for the portable device to modify the operations performed by the case (or the operations it performs) to provide the desired audio effects. For example, if the portable device detects the presence of the case, the portable device could determine or otherwise obtain the filter coefficients to be used by the filter(s) 410 or the programming to be used by the digital signal processor 505. The portable device could then provide those coefficients or programming to the case, effectively modifying the audio effects produced by the case. As a particular example, the filter coefficients or programming could be obtained from an optical disc, game cartridge, or other storage medium on which a game or other content is stored. This may allow the portable device to modify the operation of the case whenever the portable device accesses a new storage medium.

In particular embodiments, a content unit could be provided as shown in FIG. 6. FIG. 6 illustrates an example content unit 600 for customizing operation of a portable device case having a speaker array according to this disclosure. The content unit 600 includes a storage medium 602 and an optional interface unit 604. The storage medium 602 stores (and the interface unit 604 retrieves) (i) content data 606 associated with a game or other content to be presented to a user and (ii) one or more filter coefficients, DSP programming, or other data 608 defining one or more desired audio effects. The content unit 600 could represent an optical disc, a cartridge or other unit containing integrated circuitry and a storage medium, or any other suitable structure.

The portable device could also retrieve the filter coefficients or DSP programming in other ways, such as by accessing a remote server and retrieving the data over a network. Note that this represents only some examples of how different audio effects can be obtained using a portable device, and other approaches could also be used.

In general, the cases shown above can implement one or more algorithms (either in hardware, software, firmware, or combination thereof) for providing one or more desired audio effects. As an example, the algorithms could implement beam forming to enable audio energy to be steered or focused to desired location(s). In particular, the algorithms could be applied to audio signals in order to achieve at least two features: audio energy is focused in one or more beams that enable the user to receive an optimal amount of audio energy, and spatial effects are created that enable the perception of directional change of the audio content. This enables not only the concentration of audio energy for the user but also the creation of perceived audio positioning. In fact, the optimization of audio energy for the user could enable the highest energy efficiency from the portable device's power supply system. Different audio effects could be achieved using different cases, speaker array designs, filter coefficients, or other techniques.

The algorithms could also perform any desired additional functions. As a specific example, the algorithms could modify filter coefficients or perform other actions to “pre-compensate” for speaker distortions. This may be useful when used with ceramic speakers or other speakers that suffer from known distortions or other problems.

While FIGS. 1 through 6 have illustrated various features of different cases for portable devices and related components, any number of changes may be made to these drawings. For example, the components shown in the figures could be combined, omitted, or further subdivided and additional components could be added according to particular needs. Also, features shown in one or more figures above may be used in other figures above.

In some embodiments, various functions described above are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory.

It may be advantageous to set forth definitions of certain words and phrases that have been used within this patent document. The term “couple” and its derivatives refer to any direct or indirect communication between two or more components, whether or not those components are in physical contact with one another. The terms “include” and “comprise,” as well as derivatives thereof, mean inclusion without limitation. The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like.

While this disclosure has described certain embodiments and generally associated methods, alterations and permutations of these embodiments and methods will be apparent to those skilled in the art. Accordingly, the above description of example embodiments does not define or constrain this invention. Other changes, substitutions, and alterations are also possible without departing from the spirit and scope of this invention as defined by the following claims.

What is claimed is:

1. An apparatus comprising:
a case configured to be placed in association with a portable electronic device;
an interface associated with the case, the interface configured to receive audio signals from the portable electronic device; and
a speaker array associated with the case, the speaker array configured to generate audible sounds having one or more specified audio effects based on the audio signals.

2. The apparatus of claim 1, further comprising:
an audio amplifier associated with the case, the audio amplifier configured to amplify the audio signals and to provide the amplified audio signals to the speaker array.

3. The apparatus of claim 2, wherein the audio amplifier comprises a filter configured to filter the audio signals in order to produce the one or more specified audio effects.

4. The apparatus of claim 2, further comprising:
a processor configured to (i) process the audio signals in order to produce the one or more specified audio effects and (ii) output the processed audio signals to the audio amplifier.

5. The apparatus of claim 1, wherein the one or more specified audio effects vary based on at least one of: a content and a type of content presented by the portable electronic device.

6. The apparatus of claim 5, wherein the interface is configured to receive information identifying the one or more specified audio effects.

7. The apparatus of claim 1, wherein the one or more specified audio effects comprise at least one of: beam forming and sound field enhancement.

8. The apparatus of claim 1, wherein the case comprises a first portion and a second portion, the first and second portions configured to retain the portable electronic device between the first and second portions.

9. The apparatus of claim 1, wherein the interface and the speaker array are mounted in or on the case.

10. A method comprising:
attaching a portable electronic device to a case;
providing audio signals from the portable electronic device to the case; and
generating audible sounds based on the audio signals using a speaker array of the case, the audible sounds having one or more specified audio effects.

11. The method of claim 10, further comprising:
amplifying the audio signals; and
providing the amplified audio signals to the speaker array.

12. The method of claim 11, wherein amplifying the audio signals comprises filtering the audio signals in order to produce the one or more specified audio effects.

13. The method of claim 11, further comprising:
processing the audio signals in order to produce the one or more specified audio effects; and
providing the processed audio signals for amplification.

14. The method of claim 10, further comprising:
receiving information from the portable electronic device identifying the one or more specified audio effects, the one or more specified audio effects varying based on at least one of: a content and a type of content presented by the portable electronic device.

15. The method of claim 10, wherein generating the audible sounds comprises generating audible sounds that appear, from a perspective of a listener, to originate from multiple virtual sound sources.

16. A system comprising:
a portable electronic device; and
a case configured to be placed in association with the portable electronic device, the case comprising:
an interface configured to receive audio signals from the portable electronic device; and
a speaker array configured to generate audible sounds having one or more specified audio effects based on the audio signals.

17. The system of claim 16, wherein the case further comprises:
an audio amplifier configured to amplify the audio signals and to provide the amplified audio signals to the speaker array.

18. The system of claim 17, wherein the audio amplifier comprises a filter configured to filter the audio signals in order to produce the one or more specified audio effects.

19. The system of claim 17, wherein the case further comprises:
a processor configured to (i) process the audio signals in order to produce the one or more specified audio effects and (ii) output the processed audio signals to the audio amplifier.

20. The system of claim 16, wherein the one or more specified audio effects vary based on at least one of: a content and a type of content being presented by the portable electronic device.
